(19) United States
(12) Patent Application Publication
(10) Pub. No.: US 2012/0237126 A1
(43) Pub. Date: Sep. 20, 2012

(54) APPARATUS AND METHOD FOR DETERMINING CHARACTERISTIC OF MOTION PICTURE

(75) Inventors: Byeong Cheol CHOI, Daejeon (KR); Seung Wan HAN, Gwangju (KR); Jae Deok LIM, Daejeon (KR)

(73) Assignee: Electronics & Telecommunications Research Institute, Daejeon (KR)

(21) Appl. No.: 13/290,153

(22) Filed: Nov. 7, 2011

(30) Foreign Application Priority Data
Mar. 16, 2011 (KR) 10-2011-0023486

(51) Int. Cl. G06K 9/34

(52) U.S. Cl. 382/173

(57) ABSTRACT

An apparatus and method for determining a characteristic of a motion picture. The method includes dividing the motion picture into video clips and video segments of each video clip, extracting video features from each segment, determining whether or not the respective video features have a targeted characteristic according to respective predetermined references using classifiers based on the respective features and generating determination result values, statistically combining the determination result values indicating whether or not the respective video features have the targeted characteristic according to the segments to generate first combination values, statistically combining the first combination values according to the video clips to generate second combination values, statistically combining all the second combination values to generate a final combination value, and finally determining whether or not the motion picture has the targeted characteristic using the final combination value according to a predefined final point of reference.

### CLAIM FOR PRIORITY

This application claims priority to Korean Patent Application No. 10-2011-0023486 filed on Mar. 16, 2011 in the Korean Intellectual Property Office (KIPO), the entire contents of which are hereby incorporated by reference.

### BACKGROUND

1. Technical Field

Example embodiments of the present invention relate in general to an apparatus and method for determining a characteristic of a motion picture, and more particularly, to an apparatus and method for determining whether or not a motion picture has a targeted characteristic on the basis of video features extracted from the motion picture.

2. Related Art

Developments in information and communications, most notably, the Internet, offer great advantages by making useful information easy to obtain anywhere, any time, but they also have adverse effects by making harmful information easy to obtain and circulate. In particular, curious minors lacking better judgment are put at risk of exposure to harmful information. This is becoming a problem not only for individuals but for society at large.

Lately, the advent of the mobile Internet based on smartphones has facilitated greater circulation and accessibility of harmful information. Also, live streaming services such as Afreeca are appearing, and minors are being left without protection from exposure to harmful video contents. To block such harmful videos, technology for determining harmfulness of and classifying video contents is required.

When an image is input, technology for classifying harmful images determines harmfulness of the image and classifies the image. Conventionally, a content-based image retrieval technique is used to identify harmful images, but lately, research is focusing on the use of a feature of harmful images and a learning-based determination technique.

In this connection, various harmful image determination methods, such as an existing motion picture experts group (MPEG)-7 visual descriptor and a skin color detection method, have been published. However, these methods have poor classification performance because only skin color information is extracted to identify harmful images. Also, a determination method for MPEG-4 video has been proposed, but it suffers from codec and time limitations.

### SUMMARY

Accordingly, example embodiments of the present invention are provided to substantially obviate one or more problems due to limitations and disadvantages of the related art.

Example embodiments of the present invention provide a feature-based motion picture characteristic determination method that is lightweight, rapid, robust in terms of accuracy, and can be applied to general motion pictures and streaming service content.

Example embodiments of the present invention also provide a feature-based motion picture characteristic determination apparatus that is lightweight, rapid, robust in terms of accuracy, and can be applied to general motion pictures and streaming service content.

In some example embodiments, a method of determining a characteristic of a motion picture on a motion picture characteristic determination apparatus includes: dividing the motion picture into a plurality of video clips and a plurality of video segments of each of the video clips; extracting a plurality of video features from each of the segments; determining whether or not the respective video features have a targeted characteristic according to respective predetermined references using classifiers based on the respective features and generating determination result values; statistically combining the determination result values indicating whether or not the respective video features have the targeted characteristic according to the segments to generate first combination values; statistically combining the first combination values according to the video clips to generate second combination values; statistically combining all the second combination values to generate a final combination value; and finally determining whether or not the motion picture has the targeted characteristic using the final combination value according to a predefined final point of reference.

Here, the plurality of video features may be configured by combining at least one kind of temporal motion energy features (TMEF), temporal color energy features (TCEF), and temporal color histogram features (TCHF).

The TMEF may be extracted by extracting an arbitrary number of sample frames from the video segment and calculating and analyzing foreground motion energies (FMEs) of the respective extracted sample frames.

The TMEF may consist of the average and variance of the FMEs of the arbitrary number of extracted sample frames, and 16 discrete cosine transform (DCT) frequency components.

The TCEF may be extracted by extracting an arbitrary number of sample frames from the video segment and calculating and analyzing skin color energies (SCEs) of the respective extracted sample frames.

The TCEF may consist of the average and variance of the SCEs of the arbitrary number of extracted sample frames, and 16 DCT frequency components.

The TCHF may be extracted by extracting an arbitrary number of sample frames from the video segment, calculating a color histogram based on hue and saturation in a hue saturation value (HSV) color domain of each of the extracted sample frames, and calculating the hue and saturation averages according to two-dimensional bins of respective hues and saturations of the calculated color histograms of the extracted sample frames.

A supervised learning engine may be used as the classifiers.

The first combination values may be generated using an independent unbiased estimator based on the properties of point estimation theory.

The second combination values and the final combination value may be generated using simple statistical combining rules, which may include at least one of a sum rule, a product rule, a max rule, a median rule, and a majority vote rule.

An M-out-of-N determination ratio and a determination threshold value may be used to finally determine whether or not the motion picture has the targeted characteristic.

The targeted characteristic may include a characteristic of harmful motion pictures.

In other example embodiments, an apparatus for determining a characteristic of a motion picture includes: a segment divider configured to divide the motion picture into a plurality of video clips and a plurality of video segments of each of the video clips; a video feature extractor configured to extract a plurality of video features from each of the segments; a video characteristic presence/absence determiner configured to determine whether or not the respective video features have a targeted characteristic according to respective predetermined references using a supervised learning engine-based classifier, and generate determination result values; a first statistical combiner configured to generate first combination values by statistically combining the determination result values indicating whether or not the respective video features have the targeted characteristic according to the segments; a second statistical combiner configured to generate second combination values by statistically combining the first combination values according to the video clips; a third statistical combiner configured to generate a final combination value by statistically combining all the second combination values; and a motion picture characteristic determiner configured to finally determine whether or not the motion picture has the targeted characteristic using the final combination value according to a predefined final point of reference.

Here, the plurality of video features may be configured by combining at least one of a TMEF, a TCEF, and a TCHF.

The TMEF may be extracted by extracting an arbitrary number of sample frames from the video segment, calculating FMEs of the respective extracted sample frames, and analyzing the average, variance and frequency of the FMEs of the arbitrary number of extracted sample frames, the TCEF may be extracted by calculating SCEs of the respective extracted sample frames and analyzing the average, variance and frequency of the SCEs of the arbitrary number of sample frames, and the TCHF may be extracted by calculating a color histogram based on hue and saturation in an HSV color domain of each of the extracted frames and calculating hue and saturation averages according to two-dimensional bins of respective hues and saturations of the calculated color histograms of the extracted sample frames.

The first combination values may be generated using an independent unbiased estimator based on the properties of point estimation theory.

The second combination values and the final combination value may be generated using simple statistical combining rules, which may include at least one of a sum rule, a product rule, a max rule, a median rule, and a majority vote rule.

An M-out-of-N determination ratio and a determination threshold value may be used to finally determine whether or not the motion picture has the targeted characteristic.

The targeted characteristic may include a characteristic of harmful motion pictures.

### BRIEF DESCRIPTION OF DRAWINGS

Example embodiments of the present invention will become more apparent by describing in detail example embodiments of the present invention with reference to the accompanying drawings, in which:

FIG. 1 is a flowchart illustrating a process of identifying a harmful motion picture according to an example embodiment of the present invention;

FIG. 2 is a block diagram illustrating a conceptual structure of a video shown in a harmful motion picture identification process according to an example embodiment of the present invention;

FIG. 3 schematically shows a constitution of video features according to an example embodiment of the present invention;

FIG. 4A is a graph showing distribution of motion energies with respect to sample frames of a harmful video segment according to an example embodiment of the present invention;

FIG. 4B is a graph showing distribution of motion energies with respect to sample frames of a harmless video segment according to an example embodiment of the present invention;

FIG. 5A is a graph showing distribution of skin color energies (SCEs) with respect to sample frames of a harmful video segment according to an example embodiment of the present invention;

FIG. 5B is a graph showing distribution of SCEs with respect to sample frames of a harmless video segment according to an example embodiment of the present invention;

FIG. 6A shows hue-saturation (H-S) color histogram distribution in sample frames of a harmful video segment according to an example embodiment of the present invention;

FIG. 6B shows H-S color histogram distribution in sample frames of a harmless video segment according to an example embodiment of the present invention; and

FIG. 7 is a schematic block diagram of an apparatus for identifying a harmful motion picture according to an example embodiment of the present invention.

### DESCRIPTION OF EXAMPLE EMBODIMENTS OF THE PRESENT INVENTION

Example embodiments of the present invention are described below in detail with reference to the attached drawings. While specific structural and functional details about the example embodiments may be disclosed, the sole purpose of such disclosure is to enable those of ordinary skill in the art to make and practice the present invention. By no means should any details regarding the example embodiments described below or depicted in the drawings be construed as limiting the scope of the present invention, which may be embodied in many alternate forms apart from those set forth herein. The true scope of the invention is to cover all modifications, equivalents, and alternatives falling within the spirit and scope of the appended claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” with another element, it can be directly connected or coupled with the other element or intervening elements may be present. In contrast, when an element is referred to as being “directly connected” or “directly coupled” with another element, there are no intervening elements present. Other words used to describe the relationship between elements should he interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, quantities, steps, operations, elements, and/or components, but do not preclude the presence or addition of one or more other features, quantities, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms in common usage should be interpreted within the context of the relevant art and not in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

To determine whether or not a motion picture has a targeted characteristic in example embodiments of the present invention, a plurality of video features are extracted from the motion picture and a statistical combination made by a classifier based on the video features is used. Unlike image features, video features are extracted from each video scene or shot using temporal/spatial characteristics of multiple frames. In example embodiments of the present invention, a video is divided into segments, and a plurality of video features are extracted from each of the segments.

Also, a classifier determines whether or not extracted video features have a targeted characteristic. Here, the classifier refers to a technique for generating a classification model according to characteristics of categories using the extracted video features and making a determination according to the generated classification model. Example embodiments of the present invention propose application of a supervised learning engine as the classifier.

Example embodiments of the present invention disclose an apparatus and method for extracting video features, classifying the video features according to whether or not a targeted characteristic exists using a classifier, and then applying a multi-stage statistical combination method including segment-specific combination, video clip-specific combination, and final combination, to the resultant values to finally determine whether or not a motion picture has the targeted characteristic.

In the present invention, an apparatus and method for identifying a harmful motion picture are described as example embodiments of an apparatus and method for determining a characteristic of a motion picture on the basis of a video feature. Here, a harmful motion picture defined in the present invention may refer to a suggestive motion picture legally prohibited from being shown to anyone under a predetermined age.

However, identification of a harmful motion picture according to an example embodiment of the present invention is merely an example to aid in understanding an apparatus and method of the present invention, and the present invention is not limited to the example embodiment.

A video defined in the present invention may refer to only video components separated from a motion picture. Also, a video clip may refer to a portion obtained by dividing a video track into predetermined units, for example, 90 second units, and a segment may refer to a portion obtained by subdividing a video clip into predetermined units, for example, 30 second units, as the minimum determination unit.

Hereinafter, example embodiments of the present invention will be described in detail with reference to the appended drawings. Throughout the following description and all of the drawings, the same reference numerals are used to denote the same respective elements.

First, a process of identifying a harmful motion picture according to an example embodiment of the present invention and a conceptual structure of a video shown in the identification process will be briefly described, and then detailed techniques applied to respective steps so as to identify a harmful motion picture will be described.

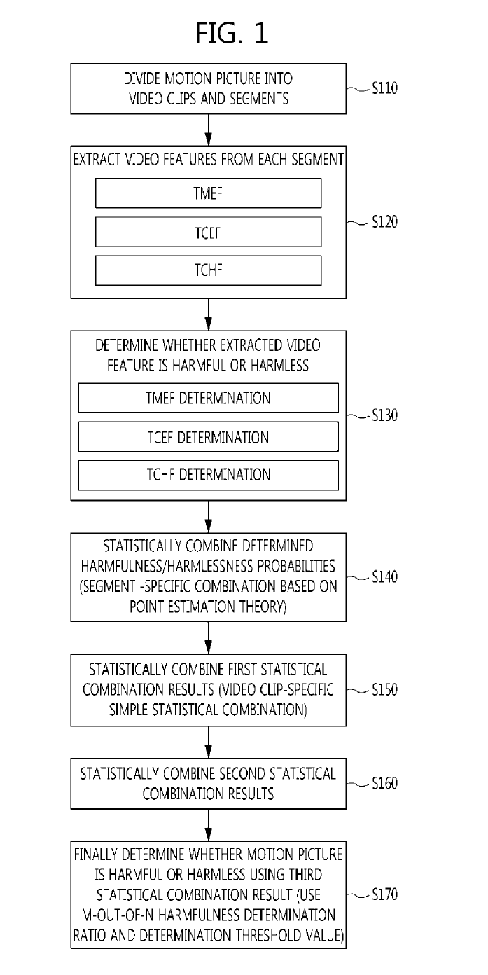

FIG. 1 is a flowchart illustrating a process of identifying a harmful motion picture according to an example embodiment of the present invention.

Referring to FIG. 1, the process of identifying a harmful motion picture according to an example embodiment of the present invention may include a step of dividing a motion picture into video clips and segments (S110), a step of extracting video features from the segments (S120), a step of determining whether the extracted video features are harmful or harmless (S130), a first statistical combination step (S140), a second statistical combination step (S150), a third statistical combination step (S160), and a step of finally determining whether the motion picture is harmful or harmless (S170).

Referring to FIG. 1, the process of identifying a harmful motion picture according to an example embodiment of the present invention may be described as follows.

In the step of dividing a motion picture into video clips and segments (S110) as a first step for determining whether a collected motion picture is harmful or harmless, a motion picture is divided into video clips by extracting video components from the motion picture, and the clips are divided into segments. Video features for determining whether a motion picture is harmful or harmless according to example embodiments of the present invention are extracted from each segment obtained in this step.

In the step of extracting video features from the segments (S120), video features are extracted from the obtained video segments. As the video features, for example, temporal motion energy features (TMEF), temporal color energy features (TCEF), and temporal color histogram features (TCHF) may be extracted.

The TMEF may be extracted by extracting an arbitrary number of sample frames from a video segment and calculating and analyzing foreground motion energies (FMEs) of the respective frames.

The TCEF may be extracted by extracting an arbitrary number of sample frames from the video segment and calculating and analyzing skin color energies (SCEs) of the respective frames.

The TCHF may be extracted by extracting an arbitrary number of sample frames from the video segment and calculating a color histogram based on hue and saturation in a hue saturation value (HSV) color domain of each of the frames.

In the step of determining whether the extracted video features are harmful or harmless (S130), a classifier is used to determine whether each of video features extracted from each segment is harmful or harmless. For example, a support vector machine (SVM) that is a supervised learning engine may be used to verify performance of visual features, so that three types of classifiers, such as a TMEF-based SVM model, a TCEF-based SVM model, and a TCHF-based SVM model, are used as estimators according to the video features to determine whether the respective video features are harmful or harmless. Since the classifiers have different performance levels, different weighting factors and different points of reference may be applied to the classifiers.

For example, a point of reference for determining whether a TCHF is harmful or harmless may be a probability of 0.5 (within a range of 0 to 1). In this case, the TCHF may be determined to be harmless if a calculated probability is within a range of 0 to 0.5, and to be harmful if the calculated probability is greater than 0.5. Likewise, the same point of reference or different points of reference may be applied to the TCEF and the TMEF.

A detailed method of extracting video features and an example of determining whether a video feature is harmful or harmless using a supervised learning engine SVM will be described later with reference to other drawings.

In the first statistical combination step (S140), results of determining whether the respective extracted video features are harmful or harmless are statistically combined. To be specific, results of determining whether the respective extracted video features are harmful or harmless are statistically combined according to the segments to generate first combination values. At this time, the determination results may be combined using an independent unbiased estimator based on point estimation theory.

In the second statistical combination step (S150), the first combination values generated in the first statistical combination step are combined according to video clips to generate second combination values. This may be performed using a simple statistical combination method.

In the third statistical combination step (S160), the second combination values that are the video clip-specific statistical combination results generated in the second statistical combination step are statistically combined to generate a final combination value. This also may be performed using the simple statistical combination method.

In the step of finally determining whether the motion picture is harmful or harmless (S170), it is finally determined whether the motion picture is harmful or harmless using the third statistical combination result, that is, the final combination value. At this time, an M-out-of-N harmfulness determination ratio, that is, a ratio indicating that M out of N clips are determined to be harmful, and a determination threshold value thereof may be used.

For example, as results of determining whether or not a motion picture is harmful, 40 out of 100 clips may be determined to be harmful after final statistical combination is performed. In this case, if a determination threshold value is set to 0.3 (30%), the motion picture will be finally determined to be harmful.

The statistical combination method will be described in further detail below.

A conceptual structure of a video shown in a process of extracting video features from video segments and statistically combining the video features according to an example embodiment of the present invention will be described in detail below with reference to a drawing.

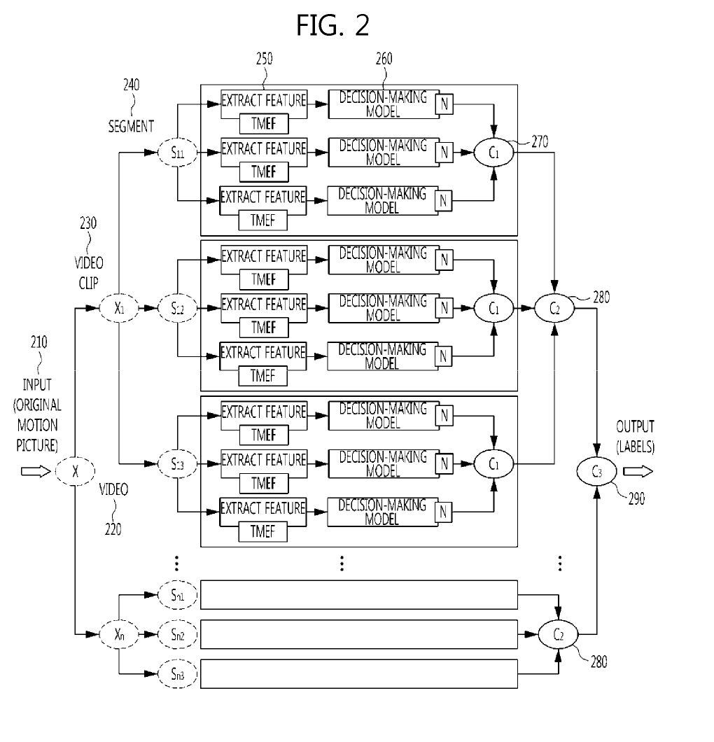

FIG. 2 is a block diagram illustrating a conceptual structure of a video shown in a harmful motion picture identification process according to an example embodiment of the present invention.

Referring to FIG. 2, the conceptual structure of a video shown in a harmful motion picture identification process according to an example embodiment of the present invention includes an original motion picture 210, a video 220, n video clips 230, a plurality of segments 240 of each video clip, a plurality of video features 250 extracted from each segment, decision-making models 260, segment-specific feature combination values (first combination) 270, clip-specific combination values (second combination) 280, and a final combination value (third combination) 290.

The conceptual structure of a video shown in a harmful motion picture identification process according to an example embodiment of the present invention may be described with reference to FIG. 2 as follows.

The original motion picture 210 is an initial image input to be identified as harmful or harmless, and includes a video track and an audio track.

The video 220 corresponds to only video components separated from the original motion picture 210 so as to be identified as harmful or harmless.

The video clips 230 are video portions obtained by dividing the video track into lengths of, for example, 90 seconds. As shown in FIG. 2, one video X includes n clips X₁ to Xₙ.

The segments 240 are obtained by subdividing a video clip into lengths of, for example, 30 seconds. The segments 240 are the smallest determination units. As shown in FIG. 2, the one video clip X₁ is divided into three segments S₁₁ to S₁₃.

The plurality of video features include TMEF, TCEF and TCHF, which are three video features of the respective segments, and the decision-making models (classifiers) 260 for determining whether respective video features are harmful or harmless are applied to the video features.

The respective features (TMEF, TCEF and TCHF) to which the decision-making models 260 are applied are statistically combined to generate first combination values C₁ 270. Also, the first combination values C₁ 270 of each clip are statistically combined to generate a second combination values C₂ 280, which are statistically combined to generate a final combination value C₃ 290. As a result, using the final combination value C₃ 290, it is finally determined whether the input motion picture 210 is harmful or harmless, and a class label indicating whether the input motion picture 210 is harmful or harmless is output.

A detailed method of extracting the above-described video features will be described below with reference to a drawing.

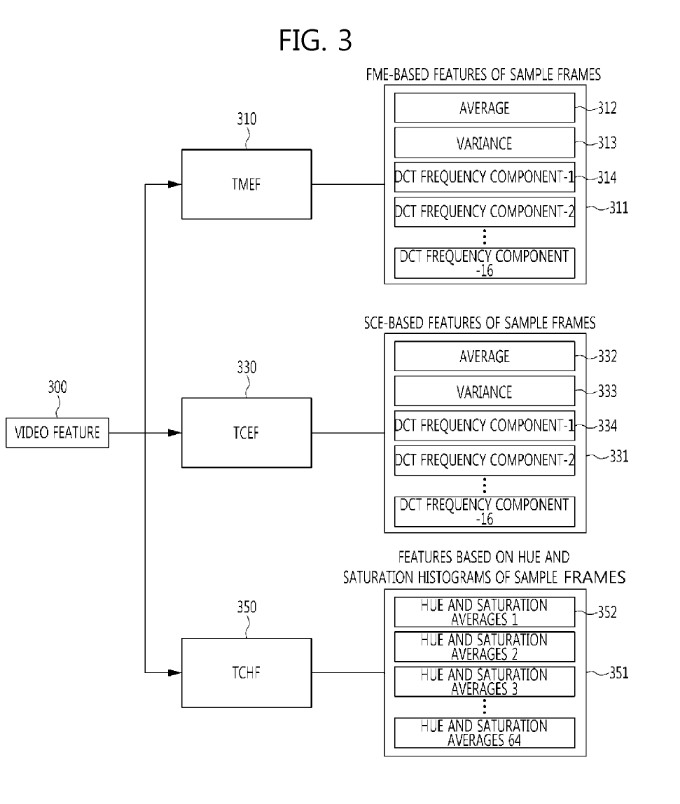

FIG. 3 schematically shows a constitution of video features according to an example embodiment of the present invention.

Referring to FIG. 3, the constitution of video features according to an example embodiment of the present invention may be described as follows.

From each segment of a video clip, three kinds of features such as TMEF 310, TCEF 330 and TCHF 350 may be extracted.

The TMEF 310 are extracted using FMEs 311 of sample frames, the TCEF 330 are extracted from SCEs of the sample frames, and the TCHF 350 are extracted using hue-saturation (H-S) color histograms 351 of the sample frames.

Methods of extracting the respective video features will be described in further detail below.

1) Extraction of TMEF

To extract the TMEF 310, n sample frames are extracted from a video segment, and FMEs of the respective extracted frames may be calculated using Equation 1 below.

$${M}_{n} = \frac{{\sum }_{x = 1}^{w} {\sum }_{y = 1}^{h} {F}_{n} ( x , y )}{w \times h} \times 100 \qquad [ Equation 1 ]$$

In Equation 1, Fₙ(x, y) denotes a motion energy of each frame, and w and h denote a width and height of the frame.

By analyzing the average, variance and frequency of FMEs of the n extracted frames, and so on, a total of 18 TMEF may be extracted. Thus, the TMEF 310 may consist of an average 312 and a variance 313 of the FMEs of the n frames and 16 discrete cosine transform (DCT) frequency components 314 as follows:

TMEF={μ_{M}, σ_{M}, X₀^{motion}, . . . , X₁₅^{motion}}

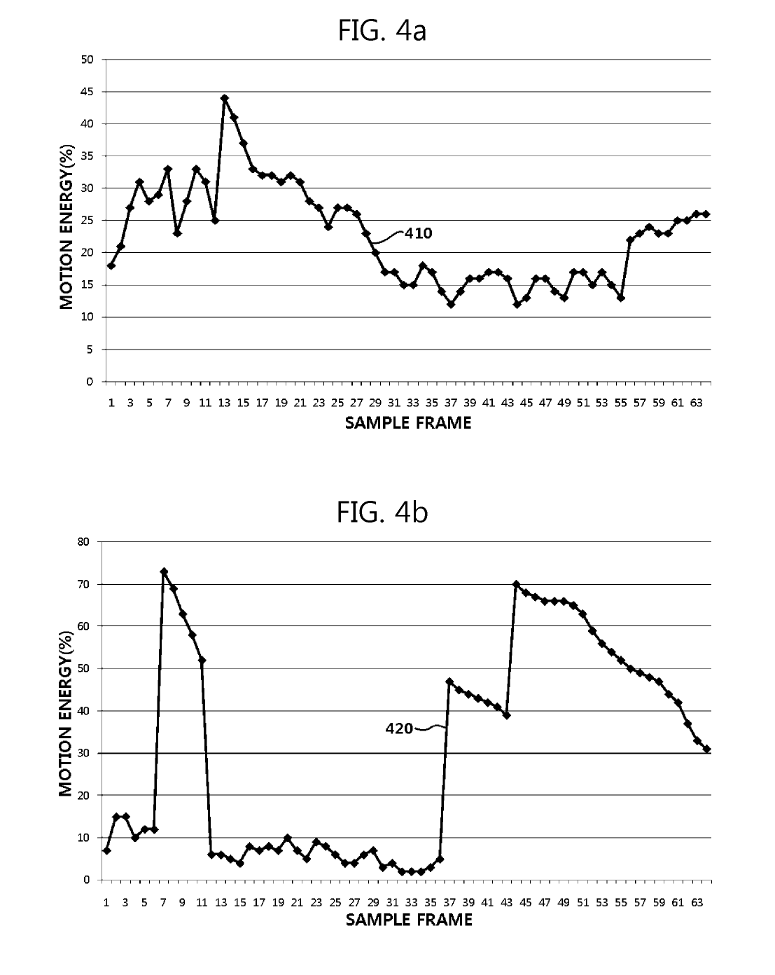

Results of determining whether TMEF extracted as described above are harmful or harmless using a classifier are shown in FIGS. 4A and 4B.

FIGS. 4A and 4B are graphs showing distribution of motion energies with respect to sample frames of harmful and harmless video segments according to an example embodiment of the present invention.

Referring to FIGS. 4A and 4B, horizontal axes of the graphs indicate sample frames, and vertical axes indicate the percentages of motion energy. While the motion energy of a harmful video shows a distribution 410 within a range of about 11% to about 45% according to sample frames, motion energy of a harmless video shows a distribution 420 within a range of about 1% to about 73%.

Thus, it is possible to know that the motion energy of a harmless video has a much higher distribution than that of a harmful video.

2) Extraction of TCEF

To extract the TCEF 330, n sample frames are extracted from a video segment, and SCEs of the respective extracted frames may be calculated using Equation 2 below.

$${C}_{n} = \frac{{\sum }_{x = 1}^{w} {\sum }_{y = 1}^{h} {S}_{n} ( x , y )}{w \times h} \times 100 \qquad [ Equation 2 ]$$

In Equation 2, Sₙ(x, y) denotes a color energy of each frame, and w and h denote a width and height of the frame.

By analyzing the average, variance and frequency of SCEs of the n extracted frames, and so on, a total of 18 TCEF are extracted. Thus, the TCEF 310 consists of an average 332 and a variance 333 of the SCEs of the n frames and 16 DCT frequency components 334 as follows:

TCEF={μ_{C}, σ_{C}, X₀^{color}, . . . , X₁₅^{color}}

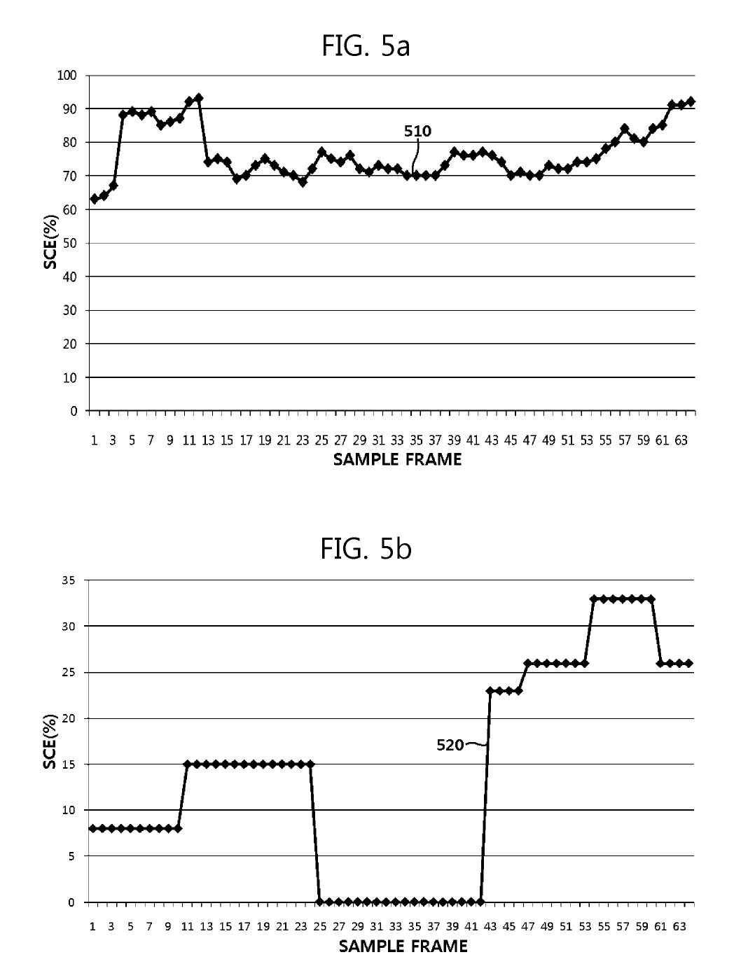

Results of determining whether TCEF extracted as described above are harmful or harmless using a classifier are shown in FIGS. 5A and 5B.

FIGS. 5A and 5B are graphs showing distribution of SCEs with respect to sample frames of harmful and harmless video segments according to an example embodiment of the present invention.

Referring to FIGS. 5A and 5B, horizontal axes of the graphs indicate sample frames, and vertical axes indicate the percentages of SCE. While the SCE of a harmful video shows a uniform distribution 510 within a range of about 61% to about 93% according to sample frames, the SCE of a harmless video shows a sharply-varying distribution 520 within a range of about 0% to about 33%.

Thus, it is possible to know that the SCE of a harmless video has a much higher average and a lower variance than those of a harmful video.

3) Extraction of TCHF

To extract the TCEF 350, n sample frames are extracted from a video segment, and a color histogram 351 based on hue and saturation values is calculated in an HSV color domain of each of the extracted frames. Also, 64 features 352 are extracted by calculating hue and saturation averages according to two-dimensional bins of respective hues (8 bins) and saturations (8 bins) of the color histograms of the n extracted frames.

This method may be described by Equation 3 below.

$$T C H F = \frac{{\sum }_{n = 1}^{N} {I}_{n} ( {h}_{i} , {s}_{j} )}{N} \qquad [ Equation 3 ]$$

In Equation 3, Iₙ(hᵢ, sⱼ) denotes a normalized color histogram of each frame, and hᵢ and sⱼ denote bins of hue and saturation, respectively (i.e., k=1, 2, . . . , 64).

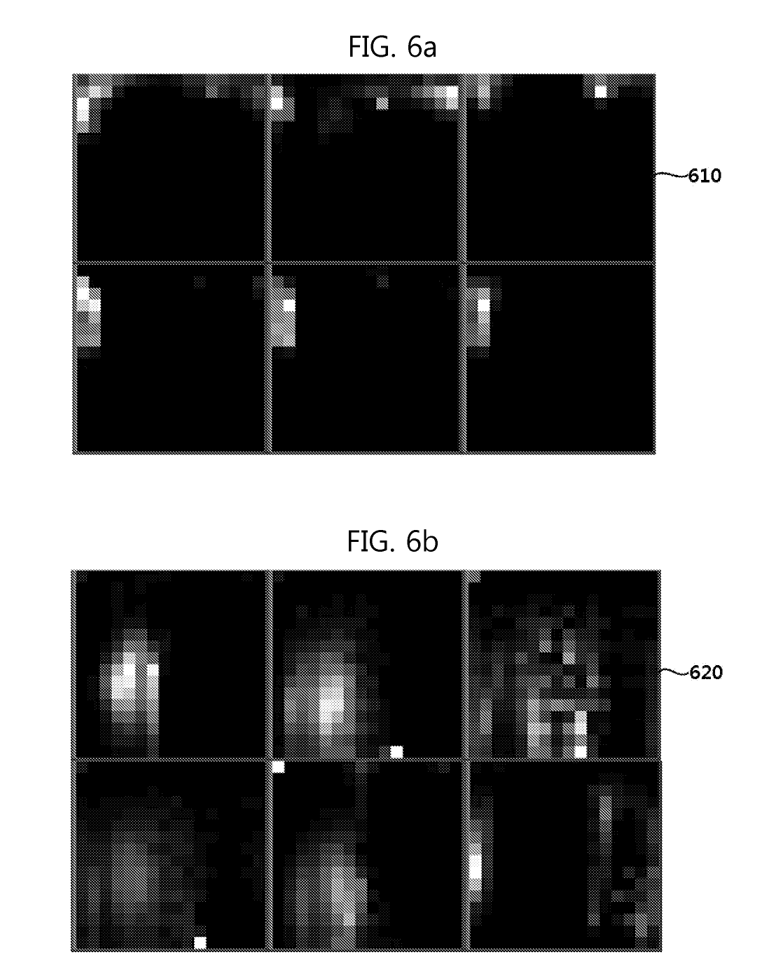

Results of determining whether TCHF extracted as described above are harmful or harmless using a classifier are shown in FIGS. 6A and 6B.

FIGS. 6A and 6B show distribution of H-S color histograms in sample frames of harmful and harmless video segments according to an example embodiment of the present invention. Referring to FIGS. 6A and 6B, an H-S color histogram distribution 610 of a harmful video is darker than an H-S color histogram distribution 620 of a harmless video and biased to one side. Thus, it is possible to know that there is clear difference in histogram distribution between the harmless video and the harmful video.

A method of statistically combining extracted video features according to an example embodiment of the present invention will be described in further detail below through an example.

1) First Statistical Combination

To statistically combine result values obtained by determining whether respective video features extracted from each video segment are harmful or harmless, an independent unbiased estimator based on the properties of point estimation theory may be used.

For example, assuming that respective classifiers are independent and unbiased, optimal classifier combination rules may be defined as Equation 4 below and used.

$$\overline{Y} = {\sum }_{i = 1}^{n} {w}_{i} {p}_{i} ( X ) \qquad [ Equation 4 ]$$

In Equation 4 above, Y̅ denotes an estimation value of an unknown real value Y. Also, wᵢ denotes a weighting factor, n denotes the number of classifiers (or extracted features), X denotes a feature, and Pᵢ(X) denotes a posterior probability of a classifier.

Meanwhile, wᵢ may be defined as in Equation 5 below.

$${w}_{i} = \frac{1 / {σ}_{i}^{2}}{{\sum }_{i = 1}^{n} 1 / {σ}_{i}^{2}} \qquad [ Equation 5 ]$$

In Equation 5 above, σᵢ² denotes a variance of a classifier, n denotes the number of classifiers, and the sum of all weighting factors becomes

$$1 ( {\sum }_{i = 1}^{n} {w}_{i} = 1 ) .$$

As can be seen from Equations 4 and 5, the variance is calculated according to the distribution of the posterior probability Pᵢ(X) of each classifier. Thus, the better the performance of a classifier, the smaller the variance.

To verify the performance of visual features, an SVM that is a supervised learning engine may be used. Because three kinds of classifiers, such as TMEF-based SVM decision model, a TCEF-based SVM decision model, and a TCHF-based SVM decision model, are used as estimators and have different performance levels, different weighting factors are applied.

2) Second and Third Statistical Combination

To perform second statistical combination using the first statistical combination results of the respective video features extracted from each segment, and third statistical combination using the second statistical combination results, simple statistical combining rules may be used. Simple statistical combining rules that can be used in example embodiments of the present invention include a sum rule, a product rule, a max rule, a median rule, a majority vote rule, etc., which may be defined as in Equations 7 to 11.

$$sumrule \text{:} \frac{1}{N} {\sum }_{i = 1}^{N} {y}_{i}^{+} \begin{matrix}{>}^{+} \\ {<}_{-}\end{matrix} \frac{1}{N} {\sum }_{i = 1}^{N} {y}_{i}^{-} \qquad [ Equation 7 ]$$

In Equation 7 above, yᵢ⁺ denotes a probability that a video segment is harmful, and yᵢ⁻ denotes a probability that a video segment is harmless. Also, N denotes the number of segments per video clip. Each of these variables has the same meaning as in the equations below.

$$\begin{matrix}product rule \text{:} \frac{{\prod }_{i = 1}^{N} {y}_{i}^{+}}{{Pr ( + )}^{N - 1}} \begin{matrix}{>}^{+} \\ {<}_{-}\end{matrix} \frac{{\prod }_{i = 1}^{N} {y}_{i}^{-}}{{Pr ( - )}^{N - 1}} & [ Equation 8 ] \\ max rule {max}_{i = 1}^{N} ( {y}_{i}^{+} ) \begin{matrix}{>}^{+} \\ {<}_{-}\end{matrix} {max}_{i = 1}^{N} ( {y}_{i}^{-} ) & [ Equation 9 ] \\ medianrule \text{:} {med}_{i = 1}^{N} ( {y}_{i}^{+} ) \begin{matrix}{>}^{+} \\ {<}_{-}\end{matrix} {med}_{i = 1}^{N} ( {y}_{i}^{-} ) & [ Equation 10 ] \\ majority vote rule \text{:} {\sum }_{i = 1}^{N} {Δ}_{i}^{+} \begin{matrix}{>}^{+} \\ {<}_{-}\end{matrix} {\sum }_{i = 1}^{N} {Δ}_{i}^{-} & [ Equation 11 ]\end{matrix}$$

Here, Δ is defined by Equation 12.

$${Δ}_{ki} = \{ \begin{matrix}1 & if Pr ( {w}_{k} \vert {x}_{i} ) = {max}_{j = 1}^{m} Pr ( {w}_{j} \vert {x}_{i} ) \\ 0 & otherwise\end{matrix} \qquad [ Equation 12 ]$$

In Equation 12, w denotes a harmful- or harmless-class label, x denotes a feature value, and m denotes the number of classes. For example, when two classes (+1: harmful class, −1: harmless class) are used, m is two.

A constitution of an apparatus for identifying a harmful motion picture according to an example embodiment of the present invention will be described below.

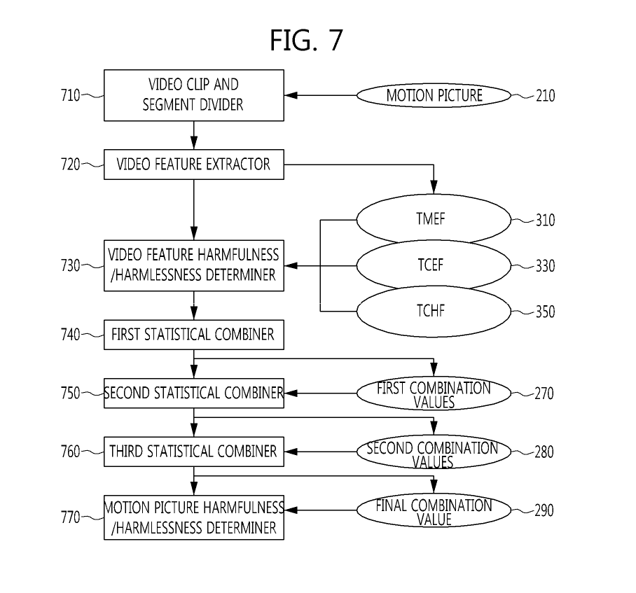

FIG. 7 is a schematic block diagram of an apparatus for identifying a harmful motion picture according to an example embodiment of the present invention.

Referring to FIG. 7, the apparatus for identifying a harmful motion picture according to an example embodiment of the present invention may include a video clip and segment divider 710, a video feature extractor 720, a video feature harmfulness/harmlessness determiner 730, a first statistical combiner 740, a second statistical combiner 750, a third statistical combiner 760, and a motion picture harmfulness/harmlessness determiner 770.

Referring to FIG. 7, the respective components of the apparatus for identifying a harmful motion picture according to an example embodiment of the present invention may be described as follows.

The video segment divider 710 extracts video components from a collected motion picture to divide the motion picture into video clips and the clips into segments.

The video feature extractor 720 extracts video features from the obtained video segments. For example, TMEF 310, TCEF 330, and TCHF 350 may be extracted as the video features.

The TMEF 310 may be extracted by extracting an arbitrary number of sample frames from a video segment and calculating and analyzing FMEs of the respective frames.

The TCEF 330 may be extracted by extracting an arbitrary number of sample frames from the video segment and calculating and analyzing SCEs of the respective frames.

The TCHF 350 may be extracted by extracting an arbitrary number of sample frames from the video segment and calculating a color histogram based on hue and saturation in an HSV color domain of each of the frames.

The video feature harmfulness/harmlessness determiner 730 determines whether respective video features extracted from each segment are harmful or harmless using a classifier.

The first statistical combiner 740 statistically combines the results of determining whether the extracted video features are harmful or harmless. To be specific, results of determining whether the respective extracted video features are harmful or harmless are statistically combined according to the segments to generate first combination values 270. At this time, the determination results may be combined using an independent unbiased estimator based on point estimation theory.

The second statistical combiner 750 combines the first combination values 270 generated in the first statistical combination step according to the video clips to generate second combination values 280. This may be performed using the simple statistical combination method.

The third statistical combiner 760 statistically combines the second combination values 280 that are the video clip-specific statistical combination results generated in the second statistical combination step, to generate a final combination value 290. This also may be performed using the simple statistical combination method.

The motion picture harmfulness/harmlessness determiner 770 finally determines whether the motion picture is harmful or harmless using the final combination value 290 generated by the third statistical combiner 760. At this time, an M-out-of-N harmfulness determination ratio, that is, a ratio indicating that M out of N clips are determined to be harmful, and a determination threshold value thereof may be used

An apparatus and method for determining a characteristic of a motion picture on the basis of a video feature according to example embodiments of the present invention extract a plurality of video features to determine whether or not a targeted characteristic exists, and statistically combine the determination results through a plurality of stages, thereby providing a motion picture determination framework that is robust in terms of time and performance. Also, the apparatus and method for determining a characteristic of a motion picture on the basis of a video feature according to example embodiments of the present invention can be effectively applied to general motion pictures and streaming service content.

While example embodiments of the present invention and their advantages have been described in detail, it should be understood that various changes, substitutions and alterations may be made herein without departing from the scope of the invention.

What is claimed is:

1. A method of determining a characteristic of a motion picture on a motion picture characteristic determination apparatus, comprising:
dividing the motion picture into a plurality of video clips and a plurality of video segments of each of the video clips;
extracting a plurality of video features from each of the segments;
determining whether or not the respective video features have a targeted characteristic according to respective predetermined references using classifiers based on the respective to features and generating determination result values;
statistically combining the determination result values indicating whether or not the respective video features have the targeted characteristic according to the segments to generate first combination values;
statistically combining the first combination values according to the video clips to generate second combination values;
statistically combining all the second combination values to generate a final combination value; and
finally determining whether or not the motion picture has the targeted characteristic using the final combination value according to a predefined final point of reference.

2. The method of claim 1, wherein the plurality of video features are configured by combining at least one kind of temporal motion energy features (TMEF), temporal color energy features (TCEF), and temporal color histogram features (TCHF).

3. The method of claim 2, wherein the TMEF are extracted by extracting an arbitrary number of sample frames from the video segment and calculating and analyzing foreground motion energies (FMEs) of the respective extracted sample frames.

4. The method of claim 3, wherein the TMEF consists of an average and variance of the FMEs of the arbitrary number of extracted sample frames, and 16 discrete cosine transform (DCT) frequency components.

5. The method of claim 2, wherein the TCEF are extracted by extracting an arbitrary number of sample frames from the video segment and calculating and analyzing skin color energies (SCEs) of the respective extracted sample frames.

6. The method of claim 5, wherein the TCEF consists of an average and variance of the SCEs of the arbitrary number of extracted sample frames, and 16 discrete cosine transform (DCT) frequency components.

7. The method of claim 2, wherein the TCHF are extracted by extracting an arbitrary number of sample frames from the video segment, calculating a color histogram based on hue and saturation in a hue saturation value (HSV) color domain of each of the extracted sample frames, and calculating hue and saturation averages according to two-dimensional bins of respective hues and saturations of the calculated color histograms of the extracted sample frames.

8. The method of claim 1, wherein a supervised learning engine is used as the classifiers.

9. The method of claim 1, wherein the first combination values are generated using an independent unbiased estimator based on properties of point estimation theory.

10. The method of claim 1, wherein the second combination values and the final combination value are generated using simple statistical combining rules including at least one of a sum rule, a product rule, a max rule, a median rule, and a majority vote rule.

11. The method of claim 1, wherein an M-out-of-N determination ratio and a determination threshold value are used to finally determine whether or not the motion picture has the targeted characteristic.

12. The method of claim 1, wherein the targeted characteristic includes a characteristic of harmful motion pictures.

13. An apparatus for determining a characteristic of a motion picture, comprising:
a segment divider configured to divide the motion picture into a plurality of video clips and a plurality of video segments of each of the video clips;
a video feature extractor configured to extract a plurality of video features from each of the segments;
a video characteristic presence/absence determiner configured to determine whether or not the respective video features have a targeted characteristic according to respective predetermined references using a supervised learning engine-based classifier, and generate determination result values;
a first statistical combiner configured to generate first combination values by statistically combining the determination result values indicating whether or not the respective video features have the targeted characteristic according to the segments;
a second statistical combiner configured to generate second combination values by statistically combining the first combination values according to the video clips;
a third statistical combiner configured to generate a final combination value by statistically combining all the second combination values; and
a motion picture characteristic determiner configured to finally determine whether or not the motion picture has the targeted characteristic using the final combination value according to a predefined final point of reference.

14. The apparatus of claim 13, wherein the plurality of video features are configured by combining at least one kind of temporal motion energy features (TMEF), temporal color energy features (TCEF), and temporal color histogram features (TCHF).

15. The apparatus of claim 14, wherein the TMEF are extracted by extracting an arbitrary number of sample frames from the video segment, calculating foreground motion energies (FMEs) of the respective extracted sample frames, and analyzing an average, variance and frequency of the FMEs of the arbitrary number of extracted sample frames,
the TCEF are extracted by calculating skin color energies (SCEs) of the respective extracted sample frames and analyzing an average, variance and a frequency of the SCEs of the arbitrary number of sample frames, and
the TCHF are extracted by calculating a color histogram based on hue and saturation in a hue saturation value (HSV) color domain of each of the extracted frames and calculating hue and saturation averages according to two-dimensional bins of respective hues and saturations of the calculated color histograms of the extracted sample frames.

16. The apparatus of claim 13, wherein the first combination values are generated using an independent unbiased estimator based on properties of point estimation theory.

17. The apparatus of claim 13, wherein the second combination values and the final combination value are generated using simple statistical combining rules including at least one of a sum rule, a product rule, a max rule, a median rule, and a majority vote rule.

18. The apparatus of claim 13, wherein an M-out-of-N determination ratio and a determination threshold value are used to finally determine whether or not the motion picture has the targeted characteristic.

19. The apparatus of claim 13, wherein the targeted characteristic includes a characteristic of harmful motion pictures.
